(19) United States
(12) Patent Application Publication
(10) Pub. No.: US 2026/0127756 A1
(43) Pub. Date: May 7, 2026

(54) GENDER IDENTIFICATION OF CHICKS USING DIGITAL IMAGE ANALYSIS

(71) Applicant: TARGAN, INC., Raleigh, NC (US)

(72) Inventors: Joshua S. GOFF, Raleigh, NC (US); David COX, Raleigh, NC (US); Daniel N. RIGGSBEE, Durham, NC (US); Jonathan M. ADAMS, Raleigh, NC (US)

(73) Assignee: TARGAN, INC., Raleigh, NC (US)

(21) Appl. No.: 19/122,648

(22) PCT Filed: Oct. 11, 2023
(86) PCT No.: PCT/US23/76521

§ 371 Date: Apr. 18, 2025

Related U.S. Application Data
(60) Provisional application No. 63/379,956, filed on Oct. 18, 2022.

(51) Int. Cl. G06T 7/70

(52) U.S. Cl. CPC G06T 7/70; G06T 2207/10024; G06T 2207/20081; G06T 2207/20084

(57) ABSTRACT

The present application is directed to identifying a gender of a chick. A method includes: causing a chick to transition along a path that is associated with a stimulus for provoking an open stance by the chick; obtaining one or more images of the chick in the open stance; determining one or more gender-related features of the chick based at least in part on the one or more images; and determining a gender of the chick based in part on the one or more gender-related features. One or more portions of the method can include any various machine learning techniques, such as supervised machine learning and/or unsupervised machine learning. For example, a supervised machine learning approach can be employed to train a neural network to identify a pose of a chick, identify gender-related features associated with the chick's wing, and/or assess the gender-related features for making a gender determination.

### CROSS-REFERENCE TO RELATED APPLICATIONS

The present application claims priority benefit to U.S. Provisional Application No. 63/379,956, entitled “Gender Identification of Chicks Using Digital Image Analysis,” filed Oct. 18, 2022, which is hereby incorporated herein by reference in its entirety.

### FIELD

The present disclosure generally relates to chick sexing and, more particularly, to feather sexing using digital image analysis.

### BACKGROUND

Chick sexing is a method of identifying the sex of chickens or other hatchlings, for example to separate female chicks or “pullets” from the males or “cockerels.” Feather sexing is a form of chick sexing based on a rate of growth of a chick's wing feathers. In particular, if the chick's primary feathers are longer than its covert feathers, the chick is identified as female; and if the covert and primary feathers are the same length, or the primary feathers are shorter than the covert feathers, then the chick is identified as male. Conventional feather sexing requires trained personnel to manually spread a wing of a chick by hand, which can be harmful to the chick's wing.

### SUMMARY

Embodiments of the present disclosure provide systems, methods, and computer readable medium with instructions for identifying a gender of a chick. A method includes causing a chick to transition along a path that is associated with a stimulus for provoking an open stance by the chick. The method further includes obtaining one or more images of the chick in the open stance, determining one or more gender-related features of the chick based at least in part on the one or more images, and determining a gender of the chick based at least in part on the one or more gender-related features. One or more portions of the method can include any various machine learning techniques, such as supervised machine learning and/or unsupervised machine learning. For example, a supervised machine learning approach can be employed to train a neural network to identify a pose of a chick, identify gender-related features associated with the chick's wing, and/or assess the gender-related features to make a gender determination.

### BRIEF DESCRIPTION OF THE DRAWINGS

Throughout the drawings, reference numbers can be re-used to indicate correspondence between referenced elements. The drawings are provided to illustrate embodiments of the present disclosure and do not limit the scope thereof.

FIG. 1A is a diagram illustrating an example of training a machine learning model in connection with present disclosure.

FIG. 1B is a diagram illustrating an example of applying a trained machine learning model to a new observation associated with identifying a gender of a chick.

FIG. 2A illustrates a chick sexing system for accurately identifying a gender of a chick in accordance with some embodiments of the present inventive concept.

FIGS. 2B-2F illustrate example comparisons of the wing feathers of male and female chicks.

FIG. 3 is a flow diagram of an example routine for determining a gender of a chick, in accordance with example embodiments.

FIGS. 4A-4F illustrate a plurality of example post-processing images of a chick transitioning along an example path.

FIGS. 5A-5F illustrate a plurality of example post-processing images of a chick transitioning along an example path.

FIG. 6 presents a bar graph illustrating example relationships between the age of a chick and the accuracy of sexing.

### DETAILED DESCRIPTION

For purposes of this disclosure, the term “chick” is used to broadly refer to any breed of chicken. In some instances, the term chick generally refers to a baby chick that is less than one day (24 hours) old. In other instances, the term chick refers to a chick that is less than two days (48 hours) old, less than one week old, or less than four weeks old. Although the disclosure generally relates to identifying a gender of a chick, it will be understood that similar gender identification techniques may be implemented on a chicken of any age, any bird, or any other animal with sex-linked characteristics that can lead to identifiable phenotype characterizations that designate gender.

For purposes of this disclosure, the term “pose” as used herein is a broad term encompassing its plain and ordinary meanings and may refer to, without limitation, position, orientation, the combination of position and orientation, or any other appropriate location information. By way of non-limiting example, a pose of a chick may refer to a position and/or orientation of the chick and/or a position and/or orientation of one or more features of the chick, such as the chick's wing.

It can be desirable to separate male and female chicks at the hatchery so that they can be managed according to their differing requirements. Feather sexing is a method of determining the gender of a newly hatched chick based on the rate of growth of its wing feathers. Using this method, if the chick's primary feathers (also referred to as “primaries”) are longer than its covert feathers (also referred to as “coverts”), then the chick is identified as female; and if the covert and primary feathers are the same length, or the primaries are shorter than the coverts, then the chick is identified as male.

Chicks often rest with their wings folded and held tight against the sides of their bodies (generally referred to herein as a “closed stance”). As such, conventional feather sexing generally requires trained personnel to manually spread a chick's wing to facilitate examination of the covert and primary feathers. Manually spreading the wings can be physically damaging to a chick's wings. Furthermore, such human-focused feather sexing methods are often unreliable (e.g., due to visual fatigue) and can be problematic in large scale applications in which the number of chicks to sex can be in the hundreds or thousands.

To address these or other problems, a chick sexing system in accordance with some embodiments of the present inventive concept can automatedly and accurately identify a gender of a chick by obtaining and processing one or more images of the chick. In particular, the bird sexing system obtains a plurality of images of the chick and processes the images to identify images in which the chick's pose is satisfactory for determining gender (e.g., the image depicts the chick with an extended wing). Furthermore, the bird sexing system can utilize machine learning techniques to identify gender-related features from the chick's wing and make a gender determination. Furthermore, in some embodiments, the bird sexing system can automatedly sort the chicks according to their gender designation.

As mentioned above, chicks often reside in a closed stance, which can increase the difficulty in obtaining an image usable for gender identification. To address these or other challenges, the bird sexing system can strategically stimulate the chick's reflexive behaviors to cause the chick to spread or extend one or both wings. For example, the bird sexing system can include a predefined path that is associated with one or more stimuli (e.g., drops, rises, speed changes, blasts of air, noises, etc.) that are intended to trigger a reflexive movement into an open stance. For purposes of this disclosure, the term “drop” or “drops” is used to broadly refer to a change in height or acceleration, or both, which can cause a chick to at least temporarily come off of the predefined path. In addition, for purposes of this disclosure, “open stance” is used to broadly refer to any pose of the chick other than a closed stance. The term open stance can generally refer to a pose in which one or both of the wings are fully extended. In addition or alternatively, the term open stance can generally refer to a pose in which one or both of the wings are partially extended. By way of non-limiting example, an open stance may refer to pose in which at least one of the chick's wings is extended at least X % of full extension (e.g., 30%, 50%, 75%, 90%). The bird sexing system can obtain a plurality of successive images that depict the chick as it transitions along the path and responds to the stimuli. In this way, the bird sexing system may increase the likelihood of obtaining one or more images that depict the chick in a satisfactory pose for determining its gender.

In light of the description herein, it will be understood that the embodiments disclosed herein may substantially improve throughput, accuracy, and safety associated with sexing chicks. Specifically, the embodiments disclosed herein enable the bird sexing system to identify the gender of hundreds or thousands of chicks efficiently and accurately, which can contrast to manual techniques that can often be unreliable on a large scale, for example due to visual fatigue and other issues associated with human error, or undesirable, for example due to issues around training and maintaining employee. Furthermore, by strategically stimulating the chick's reflexive behaviors to cause the chick to transition into an open stance, the bird sexing system advantageously reduces likelihood of harm to the chick. The ability to stimulate the chick's reflexive behaviors to at least partially extend its wing, automatically capture images of the chick with an extending wing, and automatically process the images to identify the gender of the chick enables the underlying systems to more efficiently and safety perform feather sexing by: increasing the speed/production efficiency at which the gender is determined, reducing a likelihood of injury to the chick by allowing the chick to extend its wings itself rather than being manually extended by a person, increasing an accuracy of feather sexing by reducing error associated with human involvement, etc.

Thus, the presently disclosed embodiments represent an improvement at least in video imaging and digital image analysis. Moreover, the presently disclosed embodiments address technical problems inherent within the industry. These technical problems are addressed by the various technical solutions described herein, including causing the chick to extend its wings without contact from a human, capturing images of the wing extension, selecting images that include a satisfactory chick pose, analyzing the images to identify gender-related features, determining a gender of the chick, and/or automatedly sorting the chick according to its gender designation. Thus, the present application represents a substantial improvement on existing systems in general.

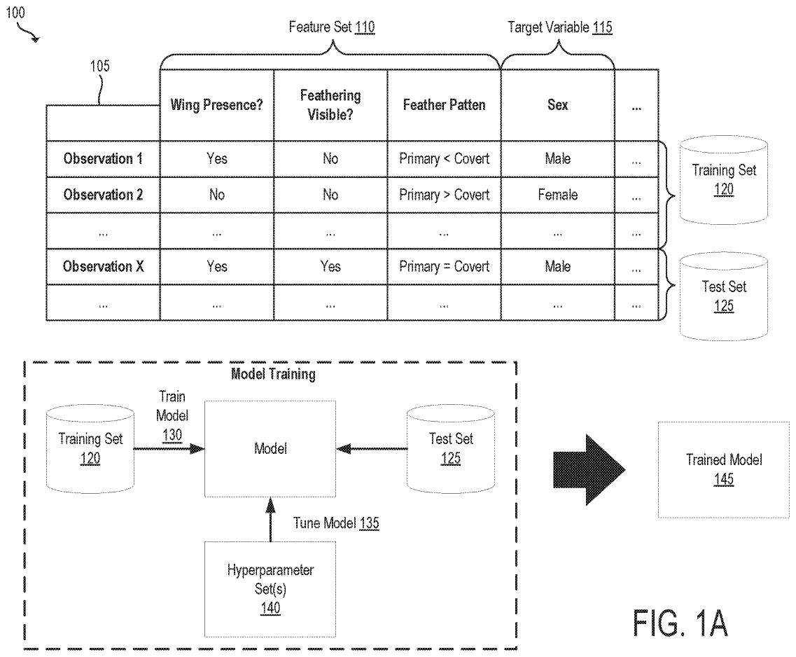

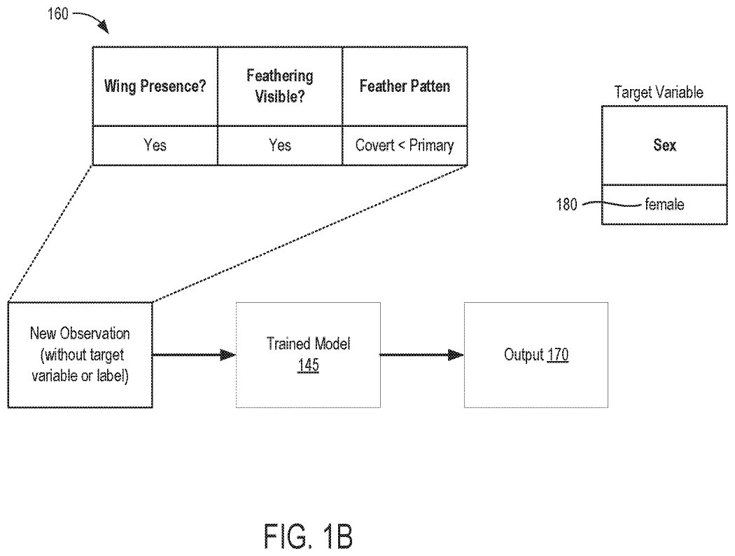

FIG. 1A is a diagram illustrating an example of training a machine learning model 100 in connection with present disclose. The machine learning model training described herein may be performed using a machine learning system. The machine learning system may include or may be included in a computing device, a server, a cloud computing environment, or the like, such as bird sexing system 200 described in more detail herein.

As shown by reference number 105, a machine learning model may be trained using a set of observations. The set of observations may be obtained and/or input from historical data, such as data gathered during one or more processes described herein. For example, the set of observations may include data gathered from the bird sexing system 200, as described elsewhere herein. In some implementations, the machine learning system may receive the set of observations (e.g., as input) from the bird sexing system 200 or from a storage device.

As shown by reference number 110, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values.

In some implementations, the machine learning system may determine variables for a set of observations and/or variable values for a specific observation based on input received from bird sexing system 200. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values.

In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of wing presence, a second feature of visible feathering, a third feature of feather pattern, and so on. As shown, for a first observation, the first feature may have a value of “yes”, the second feature may have a value of “no”, the third feature may have a value of “primary<covert”, and so on. These features and feature values are provided as examples and may differ in other examples. For example, the feature set may include one or more of the following features: bird pose, wing pose, length of covert feathers, length of primary feathers, relative length of coverts to primaries, etc. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

The set of observations may be associated with a target variable 115. The target variable 115 may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No, Male or Female), among other examples. A target variable may be associated with a target variable value, and a target variable value may be specific to an observation. In some cases, different observations may be associated with different target variable values. In example 100, the target variable 115 is sex of the bird, which has a value of “Male” for the first observation.

The feature set and target variable described above are provided as examples, and other examples may differ from what is described above. For example, for a target variable of “sex”, the feature set may include one or more of covert feather length, primary feather length, etc.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 120 that includes a first subset of observations of the set of observations, and a test set 125 that includes a second subset of observations of the set of observations. The training set 120 may be used to train (e.g., fit or tune) the machine learning model, while the test set 125 may be used to evaluate a machine learning model that is trained using the training set 120. For example, for supervised learning, the test set 125 may be used for initial model training using the first subset of observations, and the test set 125 may be used to test whether the trained model accurately predicts target variables in the second subset of observations. In some implementations, the machine learning system may partition the set of observations into the training set 120 and the test set 125 by including a first portion or a first percentage of the set of observations in the training set 120 (e.g., 75%, 80%, or 85%, among other examples) and including a second portion or a second percentage of the set of observations in the test set 125 (e.g., 25%, 20%, or 15%, among other examples). In some implementations, the machine learning system may randomly select observations to be included in the training set 120 and/or the test set 125.

As shown by reference number 130, the machine learning system may train a machine learning model using the training set 120. This training may include executing, by the machine learning system, a machine learning algorithm to determine a set of model parameters based on the training set 120. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 120). For example, for a regression algorithm, a model parameter may include a regression coefficient (e.g., a weight). For a decision tree algorithm, a model parameter may include a decision tree split location, as an example.

As shown by reference number 135, the machine learning system may use one or more hyperparameter sets 140 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the machine learning model to the training set 120. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 120. The machine learning system may tune each machine learning algorithm using one or more hyperparameter sets 140 (e.g., based on operator input that identifies hyperparameter sets 140 to be used and/or based on randomly generating hyperparameter values). The machine learning system may train a particular machine learning model using a specific machine learning algorithm and a corresponding hyperparameter set 140. In some implementations, the machine learning system may train multiple machine learning models to generate a set of model parameters for each machine learning model, where each machine learning model corresponds to a different combination of a machine learning algorithm and a hyperparameter set 140 for that machine learning algorithm.

In some implementations, the machine learning system may perform cross-validation when training a machine learning model. Cross validation can be used to obtain a reliable estimate of machine learning model performance using only the training set 120, and without using the test set 125, such as by splitting the training set 120 into a number of groups (e.g., based on operator input that identifies the number of groups and/or based on randomly selecting a number of groups) and using those groups to estimate model performance. For example, using k-fold cross-validation, observations in the training set 120 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 140 associated with a particular machine learning algorithm. The machine learning system may compare the overall cross-validation scores for different hyperparameter sets 140 associated with the particular machine learning algorithm, and may select the hyperparameter set 140 with the best (e.g., highest accuracy, lowest error, or closest to a desired threshold) overall cross-validation score for training the machine learning model. The machine learning system may then train the machine learning model using the selected hyperparameter set 140, without cross-validation (e.g., using all of data in the training set 120 without any hold-out groups), to generate a single machine learning model for a particular machine learning algorithm. The machine learning system may then test this machine learning model using the test set 125 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 145 to be used to analyze new observations, as described below in connection with FIG. 1B.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 120 (e.g., without cross-validation), and may test each machine learning model using the test set 125 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 145.

As indicated above, FIG. 1A is provided as an example. Other examples may differ from what is described in connection with FIG. 1A. For example, the machine learning model may be trained using a different process than what is described in connection with FIG. 1A. Additionally, or alternatively, the machine learning model may employ a different machine learning algorithm than what is described in connection with FIG. 1A, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

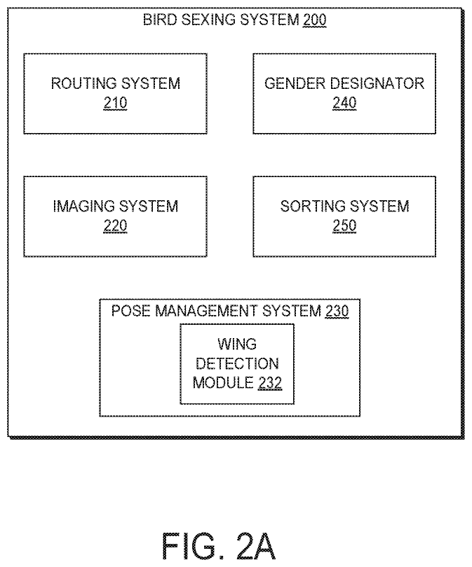

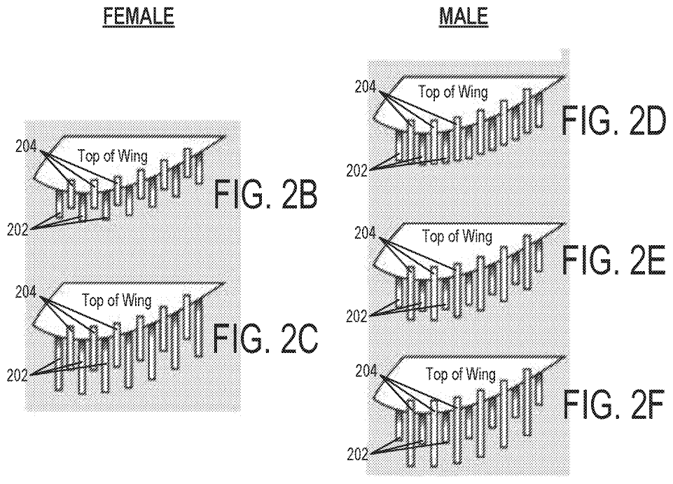

FIG. 1B is a diagram illustrating an example of applying a trained machine learning model to a new observation associated with identifying a gender of a chick. The new observation may be input to a machine learning system that stores a trained machine learning model 145, such as the trained machine learning model 145 described above in connection with FIG. 1A. The machine learning system may include or may be included in a computing device, a server, or a cloud computing environment, such as bird sexing system 200 of FIG. 2.

As shown by reference number 160, the machine learning system may receive a new observation (or a set of new observations), and may input the new observation to the machine learning model. As shown, the new observation may include a first feature of “wing presence?,” a second feature of “feathering visible?,” a third feature of “feather pattern,” and so on, as an example. The machine learning system may apply the trained machine learning model 145 to the new observation to generate an output 170 (e.g., a result). The type of output may depend on the type of machine learning model and/or the type of machine learning task being performed. For example, the output 170 may include a predicted (e.g., estimated) value of target variable (e.g., a value within a continuous range of values, a discrete value, a label, a class, or a classification), such as when supervised learning is employed. Additionally, or alternatively, the output 170 may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 145 may predict a value of “female” for the target variable of sex for the new observation, as shown by reference number 180. Based on this prediction (e.g., based on the value having a particular label or classification or based on the value satisfying or failing to satisfy a threshold), the machine learning system may provide a recommendation and/or output for determination of a recommendation, such as providing an indication that the chick is a female. Additionally, or alternatively, the machine learning system may perform an automated action and/or may cause an automated action to be performed (e.g., by instructing another device to perform the automated action), such as automatedly sorting the chick into a female bin. As another example, if the machine learning system were to predict a value of “unknown” or similar for the target variable of sex, then the machine learning system may provide a different recommendation (e.g., “manually check the sex”) and/or may perform or cause performance of a different automated action (e.g., automatedly sorting the chick into an ‘unknown’ bin). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In this way, the machine learning system may apply a rigorous and automated process to determine a sex of a chick. The machine learning system enables recognition and/or identification of tens, hundreds, thousands, or millions of features and/or feature values for tens, hundreds, thousands, or millions of observations, thereby increasing accuracy and consistency and reducing delay associated with chick sexing relative to the required resources (e.g., computing or manual) to be allocated for tens, hundreds, or thousands of operators to manually determine the sex using the features or feature values.

As indicated above, FIG. 1B is provided as an example. Other examples may differ from what is described in connection with FIG. 1B.

FIG. 2A illustrates a bird sexing system 200 for accurately identifying a gender of a chick in accordance with some embodiments of the present inventive concept. The bird sexing system 200 includes a routing system 210, an imaging system 220, a pose management system 230, a gender designator 240, and a sorting system 250. To simplify discussion and not to limit the present disclosure, FIG. 2A illustrates only one routing system 210, imaging system 220, pose management system 230, gender designator 240, and sorting system 250, though multiple may be used. Furthermore, any of these systems/elements may be combined or further separated without departing from the scope of the present inventive concept.

Any of the foregoing devices, components, or systems of the bird sexing system 200 may communicate via a network (not shown). For example, the network can include any type of communication network such as one or more of a wide area network (WAN), a local area network (LAN), a cellular network (e.g., LTE, HSPA, 3G, and other cellular technologies), an ad hoc network, a satellite network, a wired network, a wireless network, and so forth. In some embodiments, the network can include the Internet. Furthermore, it will be understood that any two of more of the routing system 210, the imaging system 220, the pose management system 230, the gender designator 240, and the sorting system 250 may be combined with one another or may be separate from the bird sexing system 200.

The routing system 210 facilitates routing, positioning, and/or orienting chicks as part of a gender identification process performed by the bird sexing system 200. The routing system 210 can define a path along which one or more chicks can transition. The path can include any physical structure defining a generally preplanned route or track. For example, the path can include a static structure (e.g., a slide) with a sloping surface along which a chick can navigate or slide to transition along the path. As another example, the path can include a dynamic structure (e.g., a conveyor belt) that transports the chick along the path. As another example, the path can include any route or track for routing or sorting a chick to a desired location.

The path may include one or more stimuli that encourage or trigger a chick to transition into an open stance. For example, a combination of one or more of the speed of the transition along the path, the slope of the path, and/or a falling sensation arising from transitioning along the path can cause the chick to spread its wings, at least temporarily. In instances in which the path includes a slide, the slide may include one or more drops in height, or acceleration increase/reduction sections that increase a likelihood that the chick will reflexively spread its wings. Similarly, in cases in which the path includes a conveyor belt, the route of the conveyor belt may include one or more height drops, belt vibration, or speed increase/reduction portions that increase a likelihood that the chick will reflexively spread its wings. As another example, the routing system 210 can include at least one stimulation apparatus along the path for encouraging a chick to reflexively spread its wings. The stimulation apparatus can include, but is not limited to, a fluid sprayer (e.g., for spraying a burst of air or water) or a noise machine. In some cases, the stimulation apparatus advantageously encourages a chick to spread or extend at least one of its wings, for example by gently starting the chick.

As described, a stimulus may increase the likelihood that the chick will extend at least one of its wings; however, in some situations, the stimulus may not actually cause the chick to extend at least one of its wings. As such, to further increase the likelihood that the chick will extend at least one of its wings at least one time during its transition along the path, the routing system 210 can include multiple stimuli and/or a persistent stimulus (e.g., a prolonged height drop). In some embodiments, at least two of the stimuli are different types of stimuli (e.g., height drop, rise, speed increase, speed decrease, fluid burst, etc.) so as to increase the likelihood that the chick with transition into an open stance at least once as it transitions along the path.

Similarly, one or more stimuli can encourage a chick to position and/or orient into a satisfactory pose. As described, the pose of the chick can affect whether an image of the chick can be utilized for reliable gender determination. As such, it can be advantageous for the routing system 210 to promote a satisfactory pose. As described in more detail below, a satisfactory pose can include any pose from which a reliable gender designation (e.g., with X % accuracy) can be determined. For example, a satisfactory pose can include, but is not limited to, the chick facing a particular direction (e.g., towards a camera, away from a camera, etc.), a threshold portion (e.g., greater 50%, 35%, etc.) of the chick being depicted in the image, the chick is not bent or hunched over, or a wing of the chick facing a particular direction (e.g., towards a camera, away from a camera, etc.).

The imaging system 220 can obtain one or more images (or video steams) of one or more chicks. For example, the imaging system 220 may include one or more cameras configured to capture one or more images and/or can include a processor configured to obtain one or more images, such as from a local or remote storage. In some cases, the imaging system 220 obtains a plurality of images of a chick corresponding to a discrete time period in which the chick transitions along the path defined by the routing system 210. In some embodiments, the imaging system 220 can capture an image of a scene that includes the chick at predetermined intervals of time, such as every X number of milliseconds, X number of seconds, etc. For example, the plurality of images can be time-series images corresponding to a frame rate of X frames per second. In addition or alternatively, the plurality of images can correspond to moments in time in which the chick is likely in a satisfactory pose, such as a moment associated with stimuli intended to encourage or trigger the chick to spread or extend at least one of its wings. By obtaining a plurality of images corresponding to the discrete time period in which the chick transitions along the path, the imaging system 220 advantageously increases a likelihood of obtaining images from which an accurate gender designation (e.g., with X % accuracy) can be determined.

The imaging system 220 can capture the images. For example, the imaging system 220 can include one or more image capture devices, which can include one or multiple types of cameras and/or lighting setups including but not limited to conventional imaging systems utilizing RGB and/or grayscale cameras with broad spectrum (e.g., white) lighting. As another example, the one or more image capture devices can include specialty hardware (e.g., to enhance the contrast of the feathers). In some cases, the imaging system 220 can be implemented as an Imaging Development Systems (IDS) camera. For example, the IDS camera can be high-performance, easy to handle USB, GigE and 3D cameras with a large range of sensors and variants, and/or the IDS camera can be a special type of camera that is adapted to work in harsh conditions (e.g., high temperatures, pressure, and vibration). As another example, the imaging system 220 can be implemented as an OAK camera. For example, the OAK camera can include OAK API software and one or more different types of hardware (e.g., OAK-1 and OAK-D). The OAK camera can be tiny artificial intelligence (AI) and computer vision (CV) powerhouses, with OAK-D providing spatial AI leveraging stereo depth in addition to the 4 K/30 12MP camera that both models share.

The imaging system 220 can store all of the captured images. Alternatively, the imaging system 220 may store only certain selected ones of the captured images. For example, the imaging system 220 may process or pre-process the images in real time or near real time to identify which images, if any, includes depicted of a chick having a satisfactory pose. The imaging system 220 may capture images of the chick as the chick transitions across the path. The plurality of images may be communicated to pose management system 230 and/or the gender designator 240 for image processing (e.g., using a machine learning algorithm) and/or display. The plurality of images may include a sequence of images taken over a predetermined time period, such as a time period over which the chick transitions along the path defined by the routing system 210 (e.g., +/−an offset).

The pose management system 230 can obtain the images from the imaging system 220 and can process the images (e.g., in real time or near real time) to determine whether an image includes a chick and/or whether a pose of the chick satisfies pose criteria. In this way, the pose management system 230 can assess an image to determine whether the image is likely to be usable in accurately determining a gender of the chick. The pose management system 230 can assess an image to determine whether the image is satisfactory or unsatisfactory. In some embodiments, the pose management system 230 determines that an image is satisfactory based at least in part on a determination the image is likely to be usable in accurately determining a gender of the chick or a determination that the chick in the image satisfies pose criteria. As a corollary, the pose management system 230 can determine that an image is unsatisfactory based at least in part on a determination the image is unlikely to be usable in accurately determining a gender of the chick or a determination that the chick in the image does not satisfy pose criteria. In some cases, the pose management system 230 determines that an image is satisfactory if the bird is at a particular location in the routing system 210 (e.g., roughly 1/3rd of the way down the slide and roughly 2 inches past the end of the slide), or within a particular field of view of the camera.

The pose management system 230 can use various criteria, which can be referred to as “pose criteria,” to determine whether determine whether an image is satisfactory or unsatisfactory. For example, if the pose of the chick satisfies the pose criteria, the pose management system 230 can determine that the image is satisfactory. As a corollary, if the pose of the chick does not satisfy the pose criteria, the pose management system 230 can determine that the image is unsatisfactory. The pose criteria can include, but are not limited to, one or more body pose thresholds, body orientation thresholds, body position thresholds, wing pose thresholds, wing orientation thresholds, wing position thresholds, body presence thresholds, etc. The pose criteria can dynamically determine whether an image is satisfactory based on any one or any combination of: body pose, wing pose, visibility of covert and/or primary wings, and so on.

As an example, the pose criteria can include a body pose threshold. The body pose threshold can correspond to a body pose of the chick which facilitates a determination of the gender. For example, the pose management system 230 can determine that body pose threshold is satisfied based at least in part on a determination that the chick is completely or substantially captured within the image. As another example, the pose management system 230 can determine that body pose threshold is satisfied based at least in part on a determination that the chick is standing up (e.g., as opposed to bent or hunched over). As another example, the pose management system 230 can determine that body pose threshold is satisfied based at least in part on a determination that the chick is facing a particular direction, such as facing towards the camera, away from the camera, such that the wing is facing the camera, etc. As a corollary, the pose management system 230 can determine that body pose threshold is not satisfied based at least in part on a determination that the chick is partially captured within the image, the chick is bent or hunched over, or the chick is facing a particular direction, such as facing away from the camera, such that the wing is not facing the camera, etc.

As another example, the pose criteria can include a body orientation threshold. For example, the pose management system 230 can determine that body orientation threshold is satisfied based at least in part on a determination that the orientation of chick in the image is conducive to an accurate gender determination. As another example, the pose criteria can include a body position threshold. For example, the pose management system 230 can determine that body position threshold is satisfied based at least in part on a determination that the position of chick in the image is conducive to an accurate gender determination.

As another example, the pose criteria can include a wing pose threshold, wing orientation threshold, or wing position threshold. For example, the pose management system 230 can determine that wing pose threshold, the wing orientation threshold, or the wing position threshold is satisfied based at least in part on a determination that the pose (e.g., position and/or orientation) of at least one wing of the chick in the image is conducive to an accurate gender determination. For example, the wing pose threshold may be determined to be satisfied based at least in part on the presence of an extended (or partially extended) wing. As another example, the wing pose threshold may be determined to be satisfied based at least in part on a presence of, or availability to identify, the covert and/or primary feathers on the wing. As a corollary, the wing pose threshold may be determined not to be satisfied based at least in part on an absence of an extended (or partially extended) wing or an absence of, or inability to identify, the covert and/or primary feathers on the wing. The pose management system 230 can include a wing detection module 232 (e.g., machine learning model/algorithm) that facilitates determination of the presence of the chick's extended wing, since wings held close to the body are not good candidates for feather detection or identification.

In the event the pose management system 230 determines that an image is unsatisfactory (e.g., based at least in part on the pose criteria), the pose management system 230 can make one or more decisions. For example, the pose management system 230 can determine that the image should not be assessed to determine gender of the chick. As such, the pose management system 230 can determine whether to discard, ignore, or choose not to select the image or data associated with the image. As another example, the pose management system 230 can determine that a gender determination associated with the image should be given a lower weighting value or confidence parameter than gender determinations associated with satisfactory images.

In the event the pose management system 230 determines that an image is satisfactory (e.g., based at least in part on the pose criteria), the pose management system 230 can make one or more decisions. For example, the pose management system 230 can determine that the image should be assessed to determine gender of the chick. As such, the pose management system 230 can determine to use or choose to select the image or data associated with the image. As another example, the pose management system 230 can determine that a gender determination associated with the image should be given a higher weighting value or confidence parameter than gender determinations associated with unsatisfactory images.

As described herein, the pose management system 230 can receive one or a plurality of images (e.g., a video stream). The pose management system 230 can select at least one image from the plurality of images. In some cases, the pose management system 230 can select an image according to an image selection policy. For example, the image selection policy can indicate to select a “best” image, where the best image can be defined as the image from which a most accurate or most confident gender prediction can be determined. As another example, the image selection policy can indicate to select an image that satisfies the pose criteria, as described herein. Furthermore, as another example, the image selection policy can indicate to select an image that corresponds to a particular timing or a particular pose (e.g., a presence of an extended wing). The image selection policy may indicate not to select any image if none of the images, for example if none of the plurality of images satisfy the pose criteria.

The gender designator 240 can determine a gender of the chick and/or a confidence parameter associated with the gender determination. In some cases, the gender designator 240 can determine multiple gender designations for a single chick. For example, as described, the imaging system 220 can obtain a plurality of images of the chick transitioning along the path of the routing system 210. In some such cases, the gender designator 240 can generate a gender determination for one, some, or each of the plurality images. Furthermore, in some case, the gender designator 240 can generate a gender determination for one or both wings of a chick. As a non-limiting example, in some cases, the right wing of a chick may indicate that the chick is a male with 75% confidence, while a left wing of the chick may indicate that the chick is male is an 82% confidence.

The gender designator 240 can determine a gender of the chick using any of a variety of techniques. For example, in some cases, the gender designator 240 implements feather detection techniques to determine the presence or absence of the covert and primary feathers on the wing. Furthermore, the gender designator 240 can assess one or more gender-related features of the covert and primary feathers to determine if the chick is male or female. The gender-related features can include, but are not limited to, a length of one or more primary feathers, a length of one or more covert feathers, or a relationship between one or more primary feathers and one or more covert feathers. The relationship can include a relative size or length comparison, such as which one or the primary or covert feathers are longer. For example, as described herein, if the primary feathers are longer than the covert feathers, then the chick is female, and if the primaries and coverts are the same length, or the primaries are shorter than the coverts, then the chick is male.

In some embodiments, one or more portions of the determination of gender can involve any one or more of various machine learning techniques, such as supervised machine learning (e.g., decision trees, nearest neighbor, support vector machines, neural networks, naive Bayes classifier, etc.) and/or unsupervised machine learning (e.g., clustering, principal component analysis, etc.). As a non-limiting example, a supervised machine learning approach can be employed to train a neural network to identify and classify the covert and primary feathers. In some such cases, as ML algorithm can include one or more layers for making decisions based on features of interest on the chicks seen in an image. Each layer assesses the image and reaches a decision, based on previously trained data, and provides that decision back to the main algorithm. Features of interest include the chick's body position, body orientation, presence of extended wings, presence/identification of the covert and primary feathers on the wings, and characteristics of the covert and primary feathers which are indicators of gender. The decisions about these features are used together to assess the gender of the chick and the quality/certainty of that decision. If multiple images contain reliable data about the chick's gender, then the algorithm combines data from the multiple images to make a final decision about the chick's gender.

The sorting system 250 can facilitate the sorting of the chick according to the gender determination. In some cases, the sorting system 250 includes an automated sorting apparatus that automatedly sorts the chicks based on the gender determination. For example, the sorting apparatus can automatedly sort or route the chick into a desired location, such as a gender-specific bin or chicken coop. In addition or alternatively, personnel may manually sort the chick according to the gender determination.

FIGS. 2B-2F illustrate example comparisons of the wing feathers of male and female chicks. In particular, FIGS. 2B and 2C illustrate example wings of female chicks, in which the coverts 204 are shorter than the primaries 202. Furthermore, FIGS. 2D-2F illustrate example wings of male chicks, in which the coverts 204 are as long as the primaries 202 (see FIG. 2D) or longer than the primaries 202 (see FIGS. 2E and 2F).

Chick sexing is the method of distinguishing the sex of chickens or other hatchlings, for example, to separate female chicks or “pullets” from the males or “cockerels.” Feather sexing is a method of chick sexing based on a rate of growth of a chick's wing feathers. In particular, if the chick's primary feathers are longer than its covert feathers, the chick is identified as female; and if the covert and primary feathers are the same length, or the primary feathers are shorter than the coverts, then the chick is identified as male. As described herein, manual feather sexing (e.g., where trained personnel physically spread a wing of a chick by hand) can be detrimental to the chick's wing. Furthermore, manual feather sexing is often unreliable on a large scale, for example, due to visual fatigue or other issues associated with human error.

To address these or other challenges, a bird sexing system 200 can automatedly and accurately identify a gender of a chick by obtaining and processing one or more images of the chick to identify gender-related features from the chick's wing and make a gender determination. Furthermore, because feather sexing involves an inspection of the chick's extended wing, the bird sexing system 200 can implement techniques to cause the chick to reflexively extend its wings, thereby advantageously reducing a likelihood of injury to the chicks during feather sexing, as compared to manually spreading the chick's wings by hand. Moreover, the bird sexing system 200 advantageously increases the speed/production efficiency at which a gender is determined, increases an accuracy of feather sexing by reducing error associated with human involvement, and facilitates large scale chick sexing.

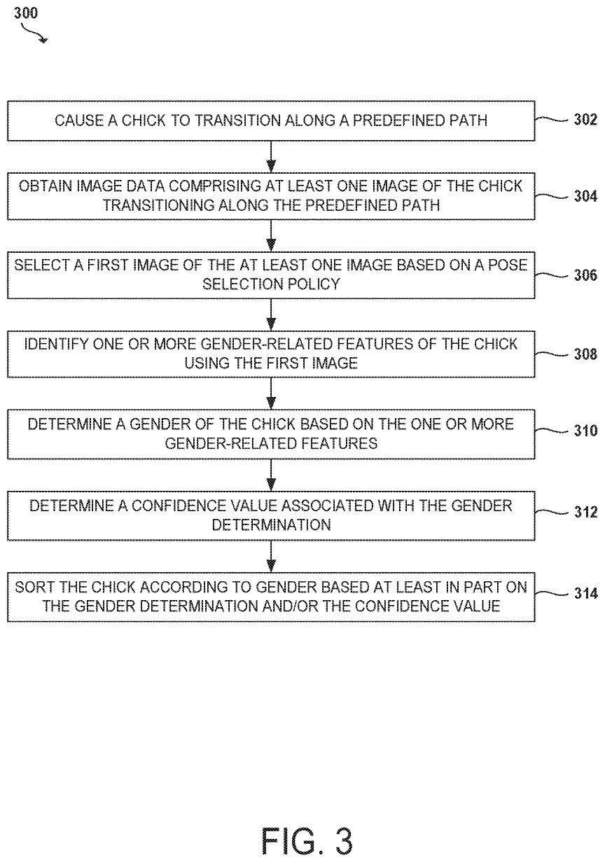

FIG. 3 is a flow diagram of an example routine 300 for determining a gender of a chick, in accordance with example embodiments. Although described as being implemented by the bird sexing system 200, it will be understood that the elements outlined for routine 300 can be implemented by any one or any combination of physical structure, hardware components, or computing devices that are associated with the bird sexing system 200. Thus, the following illustrative embodiment should not be construed as limiting.

At block 302, the bird sexing system 200 causes a chick to transition along a predefined path. As described herein, the bird sexing system 200 can define a path along which the chicks can transition as part of the gender determination process. In some cases, the path includes a physical structure defining a generally preplanned route or track. For example, the path can include a slide or other negative sloping trail, a channel, a tunnel, etc. along which a chick can navigate or be navigated (e.g., via a cart, conveyor belt, etc.).

As described herein, the path may be associated with one or more stimuli intended to provoke the chick to transition into (or remain in) an open stance. The implementation of a stimulus can vary across embodiments. For example, in some cases, the stimulus can refer to the slope or angle of the path, the speed, position, or orientation of the chick as it transitions along the path, or external acts or measures (e.g., noises, puffs of air or water) that affect the chick as the chick transitions along the path. In some such cases, a chick traveling along a path associated with a stimulus can cause the chick to feel a sensation (e.g., similar to a falling sensation felt by humans) that results in the chick reflexively opening or spreading its wings (for example to maintain balance). As such, the one or more stimuli can encourage, provoke, or trigger a chick to transition into or remain in an open stance. It will be understood that the stimulus may be passively associated with the path (e.g., a curve, slope, or transition of the path). In addition or alternatively, the stimulus may be applied or controllable by the bird sexing system 200 (e.g., a speed at which the chick transitions along the path, vibration of the conveyor belt, a presence/absence of the external act, etc.)

At block 304, the bird sexing system 200 obtains image data comprising at least one image of the chick. In some cases, the at least one image includes an image of the chick before and/or after the chick transitions along the path. In some cases, the at least one image includes an image of the chick while the chick transitions along the path. For example, the at least one image can include an image of the chick proximate (e.g., at or shortly after) the stimulus so as to increase a likelihood of capturing an image of the chick in an open stance. As another example, the at least one image can include a series of images (e.g., at X frames per second) of the chick as it transitions along the path, which may advantage increase the likelihood that at least one of the images depicts the chick in an open stance. In some cases, the bird sexing system 200 obtains the image data in real time. For example, the bird sexing system 200 may receive and process the images as the chick transitions along the path. In some cases, the bird sexing system 200 obtains the image data from a data store. For example, the imaging data may be stored in a local or remote data store and the bird sexing system 200 may retrieve the imaging data therefrom.

At block 306, the bird sexing system 200 selects at least one image of the plurality of images based on an image selection policy. As described herein, in some cases, an image of a chick may not be useful in determining the gender of the chick. For example, gender-related features of the chick may be hidden in the image. As such, in some cases, as part of a filtering process, the bird sexing system 200 can identify and/or select one, some, or all images of the plurality of images based on an image selection policy. For example, the image selection policy can indicate to select a “best” image, where the best image can be defined as the image from which a most accurate or most confident gender prediction can be determined. As another example, the image selection policy can indicate to select an image that satisfies certain pose criteria, as described herein. Furthermore, as another example, the image selection policy can indicate to select an image that corresponds to a particular timing or a particular pose (e.g., a presence of an extended wing). In some cases, the image selection policy may indicate not to select any image if none of the images, for example if none of the plurality of images satisfy the pose criteria.

In some cases, to select the at least one image, the bird sexing system 200 processes the images (e.g., in real time or near real time) to determine whether an image includes a chick and/or whether a pose of the chick satisfies pose criteria. In this way, the bird sexing system 200 can assess an image to determine whether the image is likely to be usable in accurately determining a gender of the chick. The bird sexing system 200 can assess an image to determine whether the image is satisfactory or unsatisfactory. In some cases, the bird sexing system 200 determines that an image is satisfactory based at least in part on a determination the image is likely to be usable in accurately determining a gender of the chick or a determination that the chick in the image satisfies pose criteria. As a corollary, the bird sexing system 200 can determine that an image is unsatisfactory based at least in part on a determination the image is unlikely to be usable in accurately determining a gender of the chick or a determination that the chick in the image does not satisfy pose criteria. In some cases, selecting the at least one image includes selecting one, some, or all of the images that are identified as satisfactory.

At block 308, the bird sexing system 200 identifies one or more gender-related features of the chick in the selected at least one image. The gender-related features can include, but are not limited to, a length of one or more primary feathers, a length of one or more covert feathers, or a relationship between one or more primary feathers and one or more covert feathers. The relationship can include a relative size or length comparison, such as which one or the primary or covert feathers are longer.

At block 310, the bird sexing system 200 determines a gender based at least in part on the one or more gender-related features. As described herein, the chick is determined to be a female if the chick's primary feathers are longer than its covert feathers, the chick is determined to be a male if the covert and primary feathers are the same length, or the primary feathers are shorter than the covert feathers. As described herein, in some cases, the bird sexing system 200 can determine a gender designation associated with each wing that includes visible gender-related features.

At block 312, the bird sexing system 200 determines a confidence parameter associated with the gender determination at block 310. In some cases, the confidence parameter is a number between 0 and 1 that represents the likelihood that the output of a machine learning model is correct and will satisfy a user's request. For example, the output of the bird sexing system 200 (e.g., the gender determination) can be composed of one or multiple predictions. In some such cases, each prediction can be assigned a confidence score, where the higher the score, the more confident the bird sexing system 200 is that the gender determination is correct. In some embodiments, a confidence score over 0.7 indicates that the prediction is very-likely accurate, whereas a score below 0.3 may indicate that the prediction is uncertain.

At block 314, the chick is sorted according to the sex determination and/or based on the confidence parameter. In some cases, the bird sexing system 200 includes an automated sorting apparatus. For example, the sorting apparatus can automatedly sort or route the chick into a desired location, such as a gender-specific bin or chicken coop. As another example, the bird sexing system 200 may not include an automated sorting apparatus. Rather, the gender determination and/or confidence parameter may be determined and the bird sexing system 200 may output an indication (e.g., visual display, audible noise, etc.) of the determination. In response, personnel may manually sort the chick according to the indication provided by the bird sexing system 200. In some cases, such as when the confidence parameter indicates an inconclusive sex, the chick can be sorted into a separate bin corresponding to “unknown” sex and/or the routine 300 can be rerun to reassess the chick.

Fewer, more, or different blocks can be used as part of the routine 300. In some cases, one or more blocks can be omitted. In some embodiments, the blocks of routine 300 can be combined with any one or any combination of the other blocks of routine 300. Furthermore, the routine 300 can be performed multiple times, such as tens, hundreds, or thousands of times, for the same or different chicks. For example, the bird sexing system 200 can perform the routine 300 for each chick of a group of hundreds or thousands of chicks. In some such cases, the routine 300 can be performed concurrently or successively. For example, in some cases, the bird sexing system 200 performs the routine 300 for one chick at a time, performing for each chick in succession. Alternatively, the bird sexing system 200 can perform the routine 300 concurrently for two or more chicks. For example, the bird sexing system 200 may include multiple predetermined paths that one or more chicks concurrently traverse, or the bird sexing system 200 may include a single predetermined path that multiple chicks concurrently traverse. In some such cases (e.g., where an image includes multiple chicks), the bird sexing system 200 may perform additional image processing to identify and/or track a particular chick within the image.

In some cases, the bird sexing system 200 can perform the routine 300, or portions of the routine 300, for each image of a plurality of images of the chick transitioning along the path. For example, the bird sexing system 200 may obtain an image in real time or near real time and can perform one or more steps of routine 300 on the obtained image before or independent of receipt any other images.

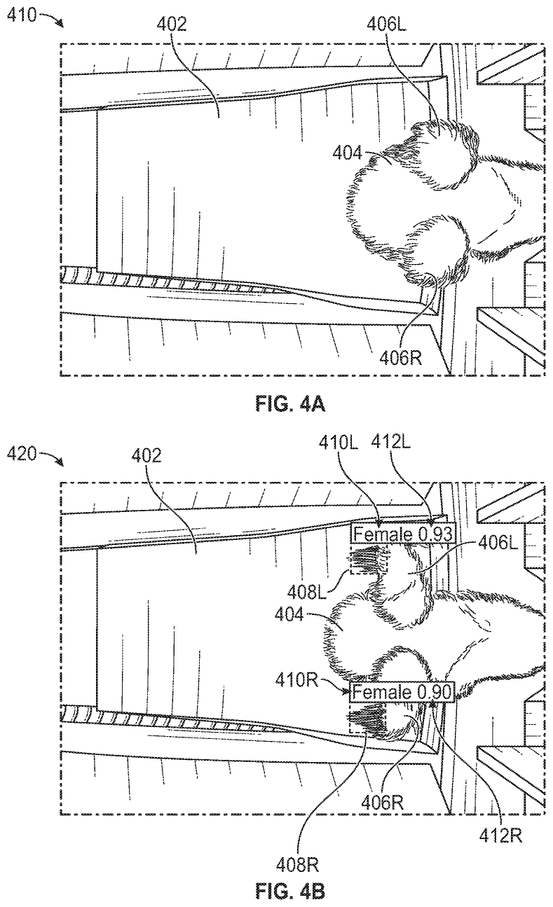

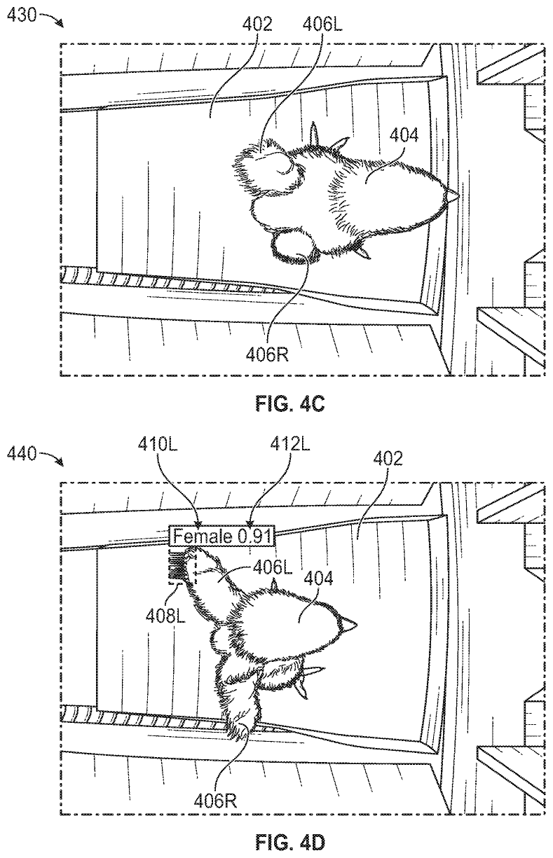

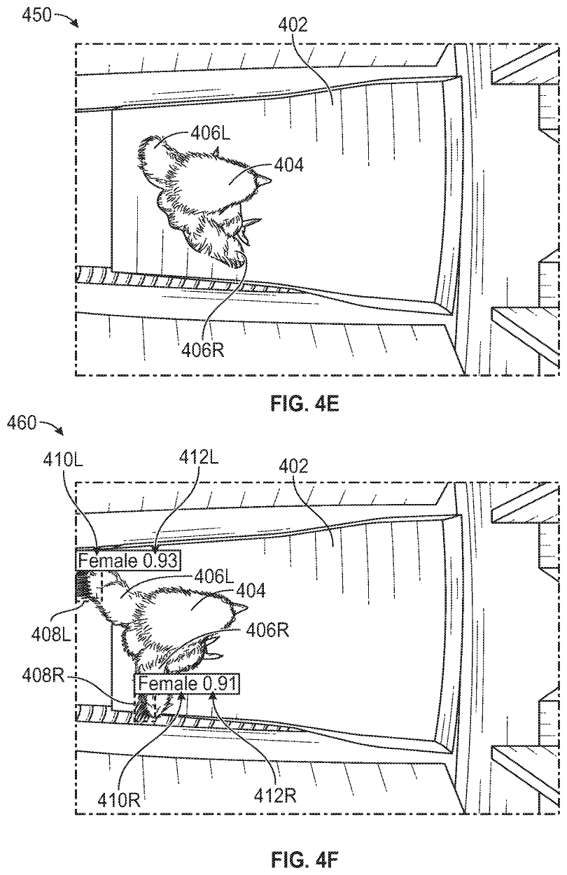

FIGS. 4A-4F are example post-processing tops views of a chick 404 transitioning along an example path 402. In these example figures, the path 402 includes a slide and the chick 404 transitions down the path 402 in a backward orientation, sequentially transitioning between the images shown in FIGS. 4A-4F. FIGS. 4A-4F are examples of output by the bird sexing system 200 as part of performing routine 300. In these examples, the chick's primary feathers are longer than its covert feathers, and thus the chick is identified as female.

FIG. 4A depicts the chick 404 at a first time as the chick 404 transitions along the path 402. For this image 410, the bird sexing system 200 determined that neither the left wing 406L nor the right wing 406R of the chick was in a satisfactory pose for determining gender. As such, the bird sexing system 200 did not generate a gender determination for FIG. 4A.

FIG. 4B depicts the chick 404 at a second time as the chick 404 transitions along the path 402. For this image 420, the bird sexing system 200 determined that both the left wing 406L and the right wing 406R of the chick are in a satisfactory pose for determining gender. For the left wing 406L, the bird sexing system 200 determined that the gender-related features 408L indicate that the chick is a female. As such, the bird sexing system 200 output a gender assignment 410L of “female” based on the gender-related features 408L of the left wing 406L. Furthermore, the bird sexing system 200 determined a confidence parameter 412L associated with gender assignment 410L of 0.93. For the right wing 406R, the bird sexing system 200 determined that the gender-related features 408R indicate that the chick is a female. As such, the bird sexing system 200 output a gender assignment 410R of “female” based on the gender-related features 408R of the right wing 406R. Furthermore, the bird sexing system 200 determined a confidence parameter 412R associated with gender assignment 410R of 0.90.

FIG. 4C depicts the chick 404 at a third time as the chick 404 transitions along the path 402. For this image 430, the bird sexing system 200 determined that neither the left wing 406L nor the right wing 406R of the chick was in a satisfactory pose for determining gender. As such, the bird sexing system 200 did not generate a gender determination for FIG. 4C.

FIG. 4D depicts the chick 404 at a fourth time as the chick 404 transitions along the path 402. For this image 440, the bird sexing system 200 determined that the left wing 406L of the chick is in a satisfactory pose for determining gender. However, the bird sexing system 200 determined that the right wing 406R was not in a satisfactory pose for determining gender. As such, the bird sexing system 200 did not generate a gender determination for the right wing 406R. For the left wing 406L, the bird sexing system 200 determined that the gender-related features 408L indicate that the chick is a female. As such, the bird sexing system 200 output a gender assignment 410L of “female” based on the gender-related features 408L of the left wing 406L. Furthermore, the bird sexing system 200 determined a confidence parameter 412L associated with gender assignment 410L of 0.91.

FIG. 4E depicts the chick 404 at a fifth time as the chick 404 transitions along the path 402. For this image 450, the bird sexing system 200 determined that neither the left wing 406L nor the right wing 406R of the chick was in a satisfactory pose for determining gender. As such, the bird sexing system 200 did not generate a gender determination for FIG. 4E.

FIG. 4F depicts the chick 404 at a sixth time as the chick 404 transitions along the path 402. For this image 460, the bird sexing system 200 determined that both the left wing 406L and the right wing 406R of the chick are in a satisfactory pose for determining gender. For the left wing 406L, the bird sexing system 200 determined that the gender-related features 408L indicate that the chick is a female. As such, the bird sexing system 200 output a gender assignment 410L of “female” based on the gender-related features 408L of the left wing 406L. Furthermore, the bird sexing system 200 determined a confidence parameter 412L associated with gender assignment 410L of 0.93. For the right wing 406R, the bird sexing system 200 determined that the gender-related features 408R indicate that the chick is a female. As such, the bird sexing system 200 output a gender assignment 410R of “female” based on the gender-related features 408R of the right wing 406R. Furthermore, the bird sexing system 200 determined a confidence parameter 412R associated with gender assignment 410R of 0.91.

As described herein, in some cases, the bird sexing system 200 can determine the gender of the chick 404 using only one image, such as any of images 420, 440, 460 of FIGS. 4B, 4D, and 4F, respectively. Alternatively, in some cases, the bird sexing system 200 can determine the gender of the chick 404 using data from a combination of two or more images. For example, the bird sexing system 200 may weight two or more determinations based on associated confidence parameters. In this case, for example since each of images 420, 440, 460 indicates that the chick is female, the bird sexing system 200 can output an overall gender determination of “female,” and the chick can be sorted accordingly.

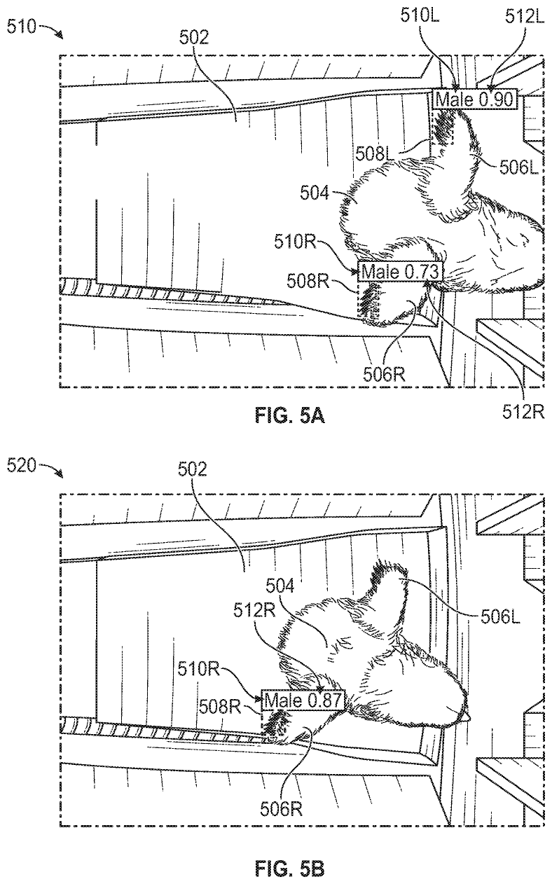

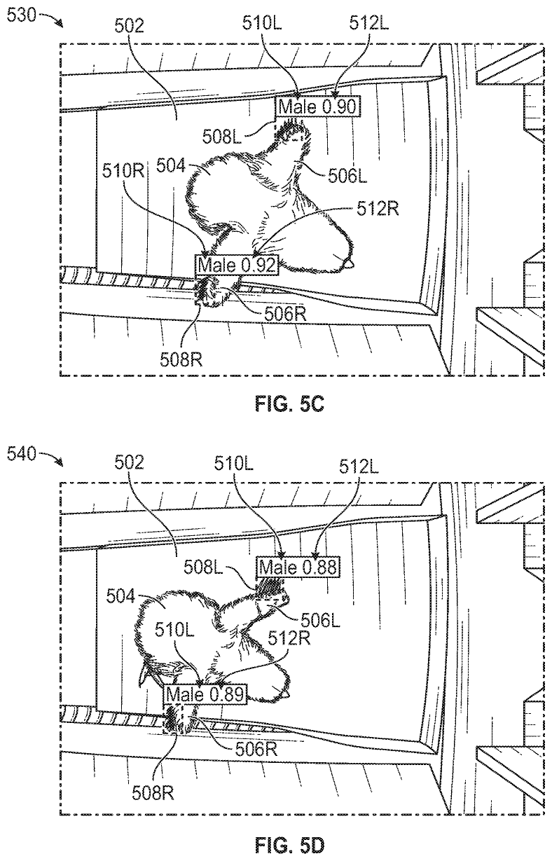

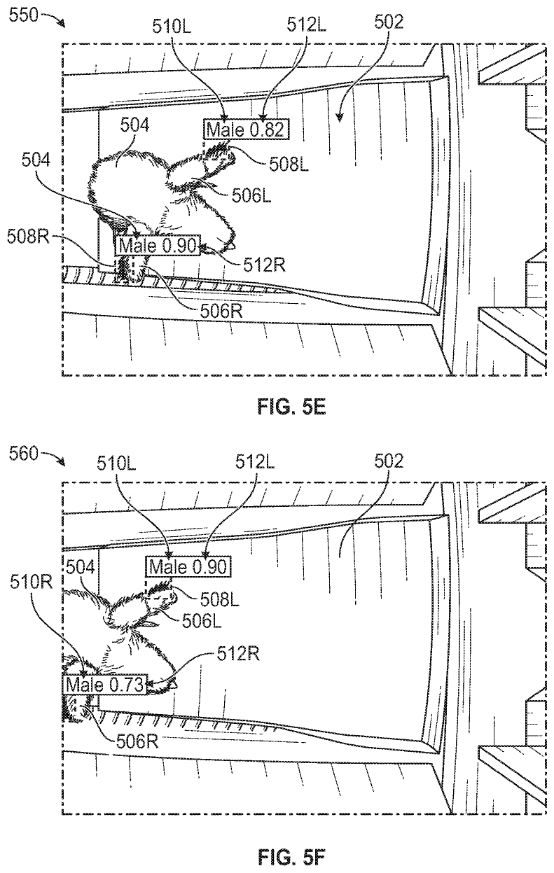

FIGS. 5A-4F are example post-processing tops views of a chick 504 transitioning along an example path 502. In these example figures, the path 502 includes a slide and the chick 504 transitions down the path 502 in a backward orientation, sequentially transitioning between the images shown in FIGS. 5A-4F. FIGS. 5A-4F are examples of output by the bird sexing system 200 as part of performing routine 300. In these examples, the chick's primary feathers are shorter than its covert feathers, and thus the chick is identified as male.

FIG. 5A depicts the chick 504 at a first time as the chick 504 transitions along the path 502. For this image 510, the bird sexing system 200 determined that both the left wing 506L and the right wing 506R of the chick are in a satisfactory pose for determining gender. For the left wing 506L, the bird sexing system 200 determined that the gender-related features 508L indicate that the chick is a male. As such, the bird sexing system 200 output a gender assignment 510L of “male” based on the gender-related features 508L of the left wing 506L. Furthermore, the bird sexing system 200 determined a confidence parameter 512L associated with gender assignment 510L of 0.90. For the right wing 506R, the bird sexing system 200 determined that the gender-related features 508R indicate that the chick is a male. As such, the bird sexing system 200 output a gender assignment 510R of “male” based on the gender-related features 508R of the right wing 506R. Furthermore, the bird sexing system 200 determined a confidence parameter 512R associated with gender assignment 510R of 0.73.

FIG. 5B depicts the chick 504 at a second time as the chick 504 transitions along the path 502. For this image 520, the bird sexing system 200 determined that the right wing 506R of the chick is in a satisfactory pose for determining gender. However, the bird sexing system 200 determined that the left wing 506L was not in a satisfactory pose for determining gender. As such, the bird sexing system 200 did not generate a gender determination for the right wing 506L. For the right wing 506R, the bird sexing system 200 determined that the gender-related features 508R indicate that the chick is a male. As such, the bird sexing system 200 output a gender assignment 510R of “male” based on the gender-related features 508R of the right wing 506R. Furthermore, the bird sexing system 200 determined a confidence parameter 512R associated with gender assignment 510R of 0.87.

FIG. 5C depicts the chick 504 at a third time as the chick 504 transitions along the path 502. For this image 530, the bird sexing system 200 determined that both the left wing 506L and the right wing 506R of the chick are in a satisfactory pose for determining gender. For the left wing 506L, the bird sexing system 200 determined that the gender-related features 508L indicate that the chick is a male. As such, the bird sexing system 200 output a gender assignment 510L of “male” based on the gender-related features 508L of the left wing 506L. Furthermore, the bird sexing system 200 determined a confidence parameter 512L associated with gender assignment 510L of 0.90. For the right wing 506R, the bird sexing system 200 determined that the gender-related features 508R indicate that the chick is a male. As such, the bird sexing system 200 output a gender assignment 510R of “male” based on the gender-related features 508R of the right wing 506R. Furthermore, the bird sexing system 200 determined a confidence parameter 512R associated with gender assignment 510R of 0.92.

FIG. 5D depicts the chick 504 at a fourth time as the chick 504 transitions along the path 502. For this image 540, the bird sexing system 200 determined that both the left wing 506L and the right wing 506R of the chick are in a satisfactory pose for determining gender. For the left wing 506L, the bird sexing system 200 determined that the gender-related features 508L indicate that the chick is a male. As such, the bird sexing system 200 output a gender assignment 510L of “male” based on the gender-related features 508L of the left wing 506L. Furthermore, the bird sexing system 200 determined a confidence parameter 512L associated with gender assignment 510L of 0.88. For the right wing 506R, the bird sexing system 200 determined that the gender-related features 508R indicate that the chick is a male. As such, the bird sexing system 200 output a gender assignment 510R of “male” based on the gender-related features 508R of the right wing 506R. Furthermore, the bird sexing system 200 determined a confidence parameter 512R associated with gender assignment 510R of 0.89.

FIG. 5E depicts the chick 504 at a fifth time as the chick 504 transitions along the path 502. For this image 550, the bird sexing system 200 determined that both the left wing 506L and the right wing 506R of the chick are in a satisfactory pose for determining gender. For the left wing 506L, the bird sexing system 200 determined that the gender-related features 508L indicate that the chick is a male. As such, the bird sexing system 200 output a gender assignment 510L of “male” based on the gender-related features 508L of the left wing 506L. Furthermore, the bird sexing system 200 determined a confidence parameter 512L associated with gender assignment 510L of 0.82. For the right wing 506R, the bird sexing system 200 determined that the gender-related features 508R indicate that the chick is a male. As such, the bird sexing system 200 output a gender assignment 510R of “male” based on the gender-related features 508R of the right wing 506R. Furthermore, the bird sexing system 200 determined a confidence parameter 512R associated with gender assignment 510R of 0.90.

FIG. 5F depicts the chick 504 at a sixth time as the chick 504 transitions along the path 502. For this image 560, the bird sexing system 200 determined that both the left wing 506L and the right wing 506R of the chick are in a satisfactory pose for determining gender. For the left wing 506L, the bird sexing system 200 determined that the gender-related features 508L indicate that the chick is a male. As such, the bird sexing system 200 output a gender assignment 510L of “male” based on the gender-related features 508L of the left wing 506L. Furthermore, the bird sexing system 200 determined a confidence parameter 512L associated with gender assignment 510L of 0.92. For the right wing 506R, the bird sexing system 200 determined that the gender-related features 508R indicate that the chick is a male. As such, the bird sexing system 200 output a gender assignment 510R of “male” based on the gender-related features 508R of the right wing 506R. Furthermore, the bird sexing system 200 determined a confidence parameter 512R associated with gender assignment 510R of 0.73.

As described herein, in some cases, the bird sexing system 200 can determine the gender of the chick 504 using only one image. Alternatively, in some cases, the bird sexing system 200 can determine the gender of the chick 504 using data from a combination of two or more images. For example, the bird sexing system 200 may weight two or more determinations based on associated confidence parameters. In this case, for example since each of images indicates that the chick is male, the bird sexing system 200 can output an overall gender determination of “male,” and the chick can be sorted accordingly.

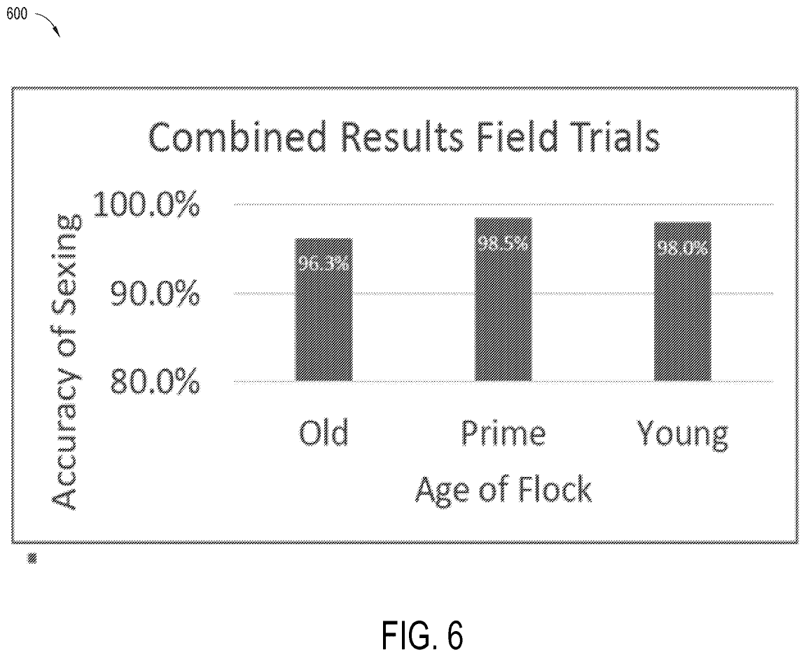

FIG. 6 presents a bar graph 500 illustrating example relationships between the age of a chick and the accuracy of sexing using the techniques and/or system described herein. The X-axis categorizes the flock into three age groups: Old, Prime, and Young. The Y-axis quantifies the accuracy of sexing in percentages.

For the age group labeled “Old,” including birds with an age range greater than or equal to 58 days, the bar graph indicates an accuracy of 96.3% in sexing. The age group labeled “Prime,” which includes birds aged between 35 to 58 days, displays an accuracy level of 98.5%. The age group categorized as “Young,” representing birds between 0 to 30 days of age, demonstrates an accuracy level of 98.0% in sexing.

The data presented in FIG. 6 was derived from two validation tests conducted on the system. The first test involved a sample of 61,800 birds, while the second test encompassed 80,000 birds. The accuracy percentages presented in FIG. 6 are based on the combined results of these two tests.

It should be recognized that the age categories or ranges for defining the “Young,” “Prime,” and “Old” groups are subject to variation across different embodiments of the system. For instance, in various embodiments, “Young” birds can be those whose ages fall within less than 10, 15, 20, 25, 30, 35, or 40 days, with a potential variation of a few days. Similarly, “Old” birds can be defined as those whose ages are at or above 30, 35, 40, 45, 50, 55, 60, 65, 70, or 75 days, also allowing for a margin of a few days. Birds categorized as “Prime” typically fall within the age range that lies between the “Young” and “Old” categories. In certain cases, a buffer period comprising a few days may exist, serving to distinguish between the age groups, such as between “Young” and “Prime” or between “Prime” and “Old.”

Embodiments of the present disclosure provide systems, methods, and computer readable medium with instructions for identifying a gender of a chick. A method includes causing a chick to transition along a path that is associated with a stimulus for provoking an open stance by the chick. The method further includes obtaining one or more images of the chick in the open stance, determining one or more gender-related features of the chick based at least in part on the one or more images, and determining a gender of the chick based at least in part on the one or more gender-related features. One or more portions of the method can include any various machine learning techniques, such as supervised machine learning and/or unsupervised machine learning. For example, a supervised machine learning approach can be employed to train a neural network to identify a pose of a chick, identify gender-related features associated with the chick's wing, and/or assess the gender-related features to make a gender determination.

### Terminology

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that the methods/steps described herein may be performed in any sequence and/or in any combination, and the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Conjunctive language such as the phrase “at least one of X, Y and Z,” unless specifically stated otherwise, is otherwise understood with the context as used in general to convey that an item, term, etc. may be either X, Y or Z, or any combination thereof. Thus, such conjunctive language is not generally intended to imply that certain embodiments require at least one of X, at least one of Y and at least one of Z to each be present. Further, use of the phrase “at least one of X, Y or Z” as used in general is to convey that an item, term, etc. may be either X, Y or Z, or any combination thereof.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 10 degrees, 5 degrees, 3 degrees, or 1 degree. As another example, in certain embodiments, the terms “generally perpendicular” and “substantially perpendicular” refer to a value, amount, or characteristic that departs from exactly perpendicular by less than or equal to 10 degrees, 5 degrees, 3 degrees, or 1 degree.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

Any patents and applications and other references noted above, including any that may be listed in accompanying filing papers, are incorporated herein by reference. Aspects of the inventive concept can be modified, if necessary, to employ the systems, functions, and concepts of the various references described above to provide yet further implementations of the inventive concept. These and other changes can be made to the inventive concept in light of the above Detailed Description. While the above description describes certain examples of the inventive concept, and describes the best mode contemplated, no matter how detailed the above appears in text, the inventive concept can be practiced in many ways. Details of the system may vary considerably in its specific implementation, while still being encompassed by the inventive concept disclosed herein. As noted above, particular terminology used when describing certain features or aspects of the inventive concept should not be taken to imply that the terminology is being redefined herein to be restricted to any specific characteristics, features, or aspects of the inventive concept with which that terminology is associated. In general, the terms used in the following claims should not be construed to limit the inventive concept to the specific examples disclosed in the specification, unless the above Detailed Description section explicitly defines such terms. Accordingly, the actual scope of the inventive concept encompasses not only the disclosed examples, but also all equivalent ways of practicing or implementing the inventive concept under the claims.

To reduce the number of claims, certain aspects of the inventive concept are presented below in certain claim forms, but the applicant contemplates other aspects of the inventive concept in any number of claim forms. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

1. A computing system comprising:
memory; and
one or more processors coupled to the memory and configured to:
obtain image data comprising a set of images of a chick, wherein the set of images of the chick corresponds to a discrete time period in which the chick transitions along a predefined path, wherein the predefined path is associated with a stimulus for provoking an open stance by the chick, wherein the open stance comprises at least a partial extension of at least one wing of the chick;
determine one or more gender-related features of the chick based on the image data; and
determine a gender of the chick based on the one or more gender-related features.

2. The system of claim 1, wherein the determination of the gender of the chick is achieved with an accuracy rate equal to or exceeding 96%.

3. The system of claim 1, wherein the one or more processors are further configured to select an image from the set of images based on a pose selection policy, wherein the selected image is inputted into a trained neural network.

4. The system of claim 3, wherein the pose selection policy indicates to select an image in which a pose of the chick satisfies pose criteria.

5. The system of claim 4, wherein the one or more processors are further configured to determine that the pose of the chick in the selected image satisfies the pose criteria.

6. The system of claim 1, wherein the pose criteria comprises at least one of a body position threshold, a body orientation threshold, a wing position threshold, or a threshold wing orientation threshold.

7. The system of claim 3, wherein the pose selection policy indicates to select an image that depicts a chick having extended wings.

8. The system of claim 1, wherein the one or more processors are further configured to:
for each image of the set of images:
determine a respective pose of the chick; and
determine whether the respective pose satisfies pose criteria.

9. The system of claim 1, wherein the set of images comprises a plurality of images, wherein each image of the set of images corresponds to a different time of the discrete time period.

10. The system of claim 1, wherein the one or more gender-related features comprises a length of a set of primary feathers or a length of a set of covert feathers.

11. The system of claim 10, wherein the length of the set of covert feathers is less than the length of the set of primary feathers, and wherein the gender output indicates that the chick is female.

12. The system of claim 10, wherein the length of the set of covert feathers is equal to or greater than the length of the set of primary feathers, and wherein the gender output indicates that the chick is male.

13. The system of claim 1, wherein the predefined path is a slide, wherein the stimulus is a downward sloping plane of the slide, wherein transitioning down the slide causes the chick to transition to the open stance.

14. The system of claim 1, wherein the predefined path comprises a conveyor belt.

15. The system of claim 14 wherein the stimulus is a speed change, a drop, or vibration of the conveyor belt.

16. The system of claim 1, wherein the stimulus comprises noise from a noise machine, or a spray of fluid activated by a fluid sprayer.

17. The system of claim 1, wherein the stimulus triggers a reflexive movement by the chick into the open stance.

18. The system of claim 1, wherein the one or more processors are further configured to automatedly sort the chick according to the gender identity output.

19. (canceled)

20. Non-transitory computer readable media comprising computer-executable instructions that, when executed by a computing system of a data intake and query system, cause the computing system to:
obtain image data comprising a set of images of a chick, wherein the set of images of the chick corresponds to a discrete time period in which the chick transitions along a predefined path, wherein the predefined path is associated with a stimulus for provoking an open stance by the chick, wherein the open stance comprises at least a partial extension of at least one wing of the chick;
determine one or more gender-related features of the chick based on the image data; and
determine a gender of the chick based on the one or more gender-related features.

21. A method for identifying a gender of a chick, the method comprising:
obtaining a set of images of a chick, wherein the set of images corresponds to a discrete time period in which the chick transitions along a predefined path, wherein the predefined path is associated with a stimulus for provoking an open stance by the chick, wherein the open stance comprises at least a partial extension of at least one wing of the chick;
inputting at least one image of the set of images of a chick into a trained neural network that characterizes one or more gender-related features of the chick;
obtaining gender identity and confidence parameter outputs from the trained neural network, wherein the gender identity output indicates a likely sex of the chick, and wherein the confidence parameter output indicates a degree of confidence associated with the gender identity output; and
causing an action based at least in part on the gender identity and confidence parameter outputs.
